(19) United States
(12) Patent Application Publication
(10) Pub. No.: US 2011/0189403 A1
(43) Pub. Date: Aug. 4, 2011

(54) Coating Material Comprising a Basic Additive

(75) Inventors: Bernd Proft, Neukirchen-Vluyn (DE); Angela Classen, Moenchengladbach (DE); Jochen Winkler, Kerken (DE)

(73) Assignee: SACHTLEBEN CHEMIE GMBH, Duisburg (DE)

(21) Appl. No.: 13/063,942

(22) PCT Filed: Sep. 15, 2009
(86) PCT No.: PCT/EP09/61978

§ 371 Date: Apr. 20, 2011

(30) Foreign Application Priority Data
Sep. 16, 2008 (DE) 10 2008 047 534.3

(51) Int. Cl. C09D 1/00; B05D 7/24; B05D 3/00; C01G 23/00

(52) U.S. Cl. 427/372.2; 423/608; 106/287.19

(57) ABSTRACT

A coating material includes an amorphous alkali titanate.

The invention refers to a coating material comprising a basic additive.

Limewash paint has been used as wall covering material for indoor and outdoor applications for a long time. In its simplest form, limewash paint is composed of slaked lime and water without any further additives. Therefore, limewash paint is strongly recommendable in view of ecological aspects and aspects of building biology. In this water-dilutable coating, lime simultaneously serves as binding agent and as pigment. The coating is humidity resistant and acts as disinfectant and fungicide. For ceilings and walls in kitchens and bathrooms, cellars and store rooms, limewash paint can be used without any problems. For outdoor applications, the paint is no longer in use due to acid rain.

The paint is applied to lime plasters, lime cement plasters and cement plasters, to formwork concrete, to fired wall stones and unfired wall stones, to walls and ceilings. During application of the limewash paint, protective glasses and protective gloves must be used as lime and cement form strong, etching alkaline solutions.

However, these coatings with limewash paint suffer from a high chalking. One speaks of chalking or farinage, respectively, in case of the formation of a finely dispersed power on the surface of the coating film during weathering, thus leading to bleaching of the colour. Even if a certain degree of chalking can be normal and even desired deterioration of the coating, a heavy chalking can lead to an excessive erosion of the coating film.

During the last decades, limewash coatings have been replaced by dispersion paints. At the beginning, they are indeed basic; however, they show a relatively fast fouling. The advantage of those paints is based on the low chalking and the good stability.

It is therefore the object of the invention to provide a coating material which shows, on one side, low affinity to formation of fouling and, on the other side, does not tend to chalking.

Surprisingly, it was found by the inventors that such coating material can be provided by adding an alkali titanate to a coating material, preferably a dispersion paint. Moreover, it was proposed by the inventors to improve the stability of coating materials and wall coverings such as wall papers by introducing a basic compound.

The problem of the invention is solved by addition of a basic alkali titanate compound or mixtures thereof to the formulation of a coating material, whereby the alkali titanate or the alkali titanates are present in an amorphous, e.g. non-crystalline form. In general, amorphous alkali titanates of the formula M_{(0,2-4)}O_{(0,1-2)} TiO₂, formally corresponding to (M₂O)_{0,1}TiO₂ to (M₂O)₂TiO₂ with M=alkali metal, thus a range of ortho-, meta- and poly-titanates such as di-, tri- or penta-titanates, can be used according to the invention.

From JP-56093772 and JP-2002194294, marine coatings with a content of alkali titanates are known. In the so described formulations however, such alkali titanates are present in crystalline form and serve for improving the resistance against sun radiation, impact resistance and the wear resistance.

Besides other alkali titanates, sodium titanate Na_{(0,2-4)}O_{(0,1-2)TiO}₂ in particular is used preferably according to the invention. Depending on the composition, sodium titanate generally contains between 50 and 67% NaOH. All compositions prepared according to the invention are colourless and strongly basic with a pH-value of more than 11. The inventors have found out that the coatings with the inventive coating agents can not be neutralized after application, even not by most intensive washing.

The addition of alkali titanate to formulations effects that the surface of the coating remains strongly basic for a long time and thus acts as anti-fouling.

The invention is therefore directed also to the use of the alkali titanate or mixtures thereof as additive in coating materials.

Coating materials, also called coating agents, to which the alkali titanate can be added, consist of liquid or paste-like substances or mixtures which, applied to surfaces, lead to a physically or chemically drying coating. According to DIN 55945, a coating agent is defined as “liquid to paste-like coating agent which is applied preferably by painting or rolling”. Basically, a coating agent is composed of: binding agent, colouring agent or pigment, respectively, filling agent, solvent, as well as optional additives such as thickening agent, dispersing agent and preservative. Coating agents which contain pigments (white pigments or coloured pigments) are designated as coating paint or stain.

Viscous coatings are designated as dispersion paints, consisting of a chemical dispersion (mostly of an emulsion), binding agents and solvents, colouring agents (mostly pigments) and additives. According to this understanding, most of the liquid coating agents (lacquers, paints, etc.) are dispersions. Main constituents are typically water as solvent, resins obtained from mineral oil or similar plastics as binding agents, colouring agents or pigments such as titan dioxide, filling agents such as calcium carbonate, silicates and quartz powder. According to the invention, auxiliary substances (so-called additives) can be used additionally, which serve for improving the technical properties, such as wetting agents and dispersing agents, defoaming agents, thickening agents and preservatives. The resins as used are, for example, acrylates or polyvinylacetate. If systems with a high content of binding agents are used (PVC (Particle-Volume-Concentration—PVK) approximately 25-40% at a solid content (FK) of 40 to 50%) they are designated as latex-systems. They mostly contain acrylate/styrole-dispersions.

Wall paints, composed of a resin dispersion, with a particular high water resistance for outdoor areas and facade areas as well as for humid areas in the house are often indicated as latex paints having an increased portion of synthetic resins. Synthetic resin dispersion paints with decorative additives (such as glitter) are also often designated similarly. Besides a liquid synthetic resin dispersion paint, thixotropic (so-called compact) coatings are also available, better known as “Feste Farbe”®; they are supposed to less blotting and splashing during painting.

According to the invention, alkali titanate can be added to all of these coating agents to improve the stability of the coating.

As solvent for the inventive coating agent, water is generally used. Nevertheless, coating paints with a content of organic solvent are also possible.

Inorganic as well as organic pigments can be added thereto. Pigments are used in view of their light scattering properties. They impart the colour impression to the coating by reflection or by selective or complete absorption of the light.

Basically, filling agents are used for cheapening but also for modifying the properties of the coating paints. The particle-volume-concentration PVC (PVK) can be adjusted to values above the critical PVC when using filling agents in the coating paints, which causes the Dry-Hiding-Effect.

Mostly, a combination of different filling agents is used in the coating paints, to positively influence the mechanical properties of the film. Typical filling agents are calcium carbonate, kaolin, talcum and glimmer.

The inventive coating agents can also contain surface active substances which influence physically the boundary layers between different phases. Generally, wetting agents are used which facilitate, or allow in a first place, the dispersion of pigments and filling agents, respectively. They also serve for stabilising the pigments and filling agents, to avoid undesired phenomena like flocculation or sedimentation.

According to the invention, thickening agents can be used which are mainly capable of binding water. By removing of unbound water, the viscosity is increased. Above a concentration being characteristic for each thickening agent, network effects which lead to an overproportional increase of viscosity add up to this effect. Those thickening agents are generally linear or branched macromolecules (for example polysaccharides or proteins) which interact by means of intermolecular interactions such as hydrogen bonds, hydrophobic interactions or ion relations. Examples of thickening agents are sheet silicates (bentonite, hectorite) or hydrated SiO₂-particles which can be present as dispersed particles and which can bind water within their solid-state-like structure or can interact due to the above described interactions.

Examples for the softening agents which can be used according to the invention are dibutyl phthalate, dioctyl phthalate and tripropylene glycol mono-isobutyrate, which are added in order to lower the MFFT (minimum film forming temperature). The softening agents do not undergo any chemical reaction with the material but change it physically only. Solvents are often used for decreasing the MFFT. They are designated as film forming auxiliary means or coalescence means. Typical solvents are glycol ether and its acetate and increasingly high boiling solvents such as texanol or esters of dicarboxylic acids.

As inventive defoaming agents, formulations such as mineral oil defoaming agents and silicon defoaming agents with distinct surface activity can be used which are capable of suppressing an undesired foam formation or destroy foam already being formed. Compounds made from silicon oils and hydrophobic silicic acid particles or wax particles being introduced therein can be used as heterogeneous defoaming agents.

Though the inventive formulation is generally sufficiently resistant, the inventive coating agent can additionally contain preservatives which avoid the infestation of the dispersion by microorganisms such as bacteria, fungi (mould) and yeasts during storage and transport of the same (pot preservation). For exterior coatings, preparations can be added to the coating agents as film preservatives for hindering the infestation by microorganisms.

The inventive coating agents can be present in the form of paints, plasters, grout masses, wall papers or wall paper paste. There are no limitations known which limit the usability as long as the components as chosen are resistant in the alkaline environment. The invention will be further illustrated by the following preparation examples below.

### PREPARATION EXAMPLE 1

A house paint comprising 3% Na-titanate was prepared according to the following formulation:

| Component | Weight portions |
|---|---|
| Water | 31.400 |
| Wetting agent | 0.400 |
| Biocide | 0.400 |
| Thickening agent | 0.500 |
| Defoaming agent | 0.300 |
| pH-Value-adjustment | 0.100 |
| Na-titanate | 3.000 |
| Hombitan R 210 | 12.000 |
| Filling agents | 33.100 |
| Silicon resin | 9.300 |
| Styrol acrylate | 9.500 |
| Sum of weight portions | 100.000 |

### PREPARATION EXAMPLE 2

A house paint comprising 5% Na-titanate was prepared according to the following formulation:

| Component | Weight portions |
|---|---|
| Water | 31.400 |
| Wetting agent | 0.400 |
| Biocide | 0.400 |
| Thickening agent | 0.500 |
| Defoaming agent | 0.300 |
| pH-Value-adjustment | 0.100 |
| Na-titanate | 5.000 |
| Hombitan R 210 | 12.000 |
| Filling agents | 31.100 |
| Silicon resin | 9.300 |
| Styrol acrylate | 9.500 |
| Sum of weight portions | 100.000 |

### COMPARATIVE EXAMPLE

A house paint without Na-titanate was prepared according to the following formulation:

| Component | Weight portions |
|---|---|
| Water | 31.400 |
| Wetting agent | 0.400 |
| Biocide | 0.400 |
| Thickening agent | 0.500 |
| Defoaming agent | 0.300 |
| pH-Value-adjustment | 0.100 |
| Hombitan R 210 | 12.000 |
| Filling agents | 36.100 |
| Silicon resin | 9.300 |
| Styrol acrylate | 9.500 |
| Sum of weight portions | 100.000 |

Using the formulations of the Preparation Examples and the Comparative Example, coatings have been applied to test sheets and subjected to weathering tests. Thereby, the inventive formulations did not show any fouling or chalking whereas this occurred almost after a short period of time when using the formulation according to the Comparative Example.

1. Coating material comprising an amorphous alkali titanate.

2. Coating material according to claim 1 comprising up to 10% by weight of an amorphous alkali titanate of the formula M_{0.2-4)}O_{0.1-2)}TiO₂ wherein M represents an alkali metal.

3. Coating material according to claim 1 comprising up to 10% by weight sodium titanate.

4. Coating material according to claim 1 in the form of a wall paint, wall plaster or compact paint.

5-8. (canceled)

9. Coating material according to claim 1 wherein the amorphous alkali titanate has a formula (M₂O)_{0.1}TiO₂ to (M₂O)₂TiO₂, wherein M represents an alkali metal.

10. A wall paint comprising the coating material according to claim 1.

11. A compact paint comprising the coating material according to claim 1.

12. A wall plaster comprising the coating material according to claim 1.

13. A coating material comprising an alkali titanate or mixtures of different alkali titanates for stabilizing a coating.

14. A coating material according to claim 13, comprising an amorphous alkali titanate of the formula M_{(0.2-4)}O_{(0.1-2)}TiO₂, whereby M represents an alkali metal.

15. A coating material according to claim 13, comprising an amorphous alkali titanate in an amount of up to 10% by weight.

16. A coating material according to claim 13, wherein the alkali titanate comprises sodium titanate.

17. A method of stabilizing a coating, comprising:
adding an alkali titanate or mixtures of different alkali titanates to a coating agent;
applying the coating agent to a surface; and
drying the coating agent.

18. A method according to claim 17, comprising adding an amorphous alkali titanate of the formula M_{(0.2-4)}O_{(0.1-2)}TiO₂, wherein M represents an alkali metal, to the coating agent.
